(19) United States
(12) Patent Application Publication
(10) Pub. No.: US 2006/0281369 A1
(43) Pub. Date: Dec. 14, 2006

(54) POWER PLUG OF A PERIPHERAL DEVICE AND CORRESPONDING SOCKET THEREOF

(75) Inventors: Kuo-Chun Lee, Taoyuan Shien (TW); Ju-Ping Wang, Jiangsu Province (CN); Chi-Hung Chen, Taoyuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/419,516

(22) Filed: May 22, 2006

(30) Foreign Application Priority Data
Jun. 9, 2005 (TW) 94119135

(51) Int. Cl. H01R 13/64

(52) U.S. Cl. 439/680

(57) ABSTRACT

A power plug of a peripheral device for electrically connecting a socket is provided. The power plug includes a first plug pin, a second plug pin, a third plug pin and a fourth plug pin respectively protrude a first length, a second length, a third length and a fourth length from a datum plane of the power plug. The second length is larger than the first length, the third length is substantially the same with the second length, and the fourth length is smaller than the second length. While the power plug is electrically connected to the socket, the second plug pin and the third plug pin respectively contact a second socket pin and a third socket pin first, and then the first plug pin and the fourth plug pin respectively contact a first socket pin and a fourth socket pin to generate an electrical connection.

This application claims the benefit of Taiwan application Serial No. 94119135, filed Jun. 9, 2005, the subject matter of which is incorporated herein by reference.

### BACKGROUND OF THE INVENTION

1. Field of the Invention

The invention relates in general to a power plug and a corresponding socket thereof, and more particularly to a power plug of a peripheral device and a corresponding socket thereof.

2. Description of the Related Art

Along with the advance in science and technology, computers have been widely applied to people's everyday life. A computer is normally equipped with a data storage device such as hard disc drive, floppy disc drive or optical disc drive for storing data. A computer, which is also equipped with a power supplier for connecting an external power source, is electrically connected to a socket disposed on storage device via a power plug coupled to the power supplier to supply power to the computer.

Referring to FIG. 1A and FIG. 1B, a three-dimensional diagram and a cross-sectional view of a conventional power plug and a conventional socket are respectively shown. In FIG. 1A and FIG. 1B, a power plug 100 is coupled to a power supplier (not shown in the diagram), and a socket 150 can be disposed in an optical disc drive (not shown in the diagram) for instance. The power plug 100 is coupled to the socket 150 in a manner that the power plug 100 can be plugged from or into the socket 150. The power plug 100 has four plug pins 112, 114, 116 and 118, and are respectively coupled to a 5V voltage, a ground end GND, a ground end GND and a 12V voltage provided by the power supplier. The 5V voltage can be used for providing an ordinary IC with necessary power for instance, and the 12V voltage can be used for driving the motor for instance. The socket 150 has several socket pins 162, 164,166 and 168 respectively contacting four plug pins 112, 114, 116 and 118 to generate an electrical connection.

It can be seen from FIG. 1B that the four plug pins 112, 114, 116 and 118 are of the same length, and so are the four socket pins 162, 164, 166 and 168 of the same length. Under normal circumstances, when the power plug 100 is connected to the socket 150, the plug pins 112, 114, 116 and 118 respectively contact the socket pins 162, 164, 166 and 168 to generate an electrical connection. Therefore, the electrostatic discharges (EDS) would inevitably cause damage to the storage device.

Besides, the design of conventional power plug and the socket is susceptible to unexpected short-circuits under certain circumstances. For example, when the power plug 100 is connected to but not aligned with the socket 150, such a coupling between the plug pin 112 and the socket pin 164 would cause a short-circuit as shown in FIG. 2A, the coupling between the plug pin 118 and the socket pin 166 as shown in FIG. 2B would results in a short-circuit or causes the computer to break down. To the worse of that, the driver or even the computer might be burn down, or the user might even be exposed to an electric shock.

### SUMMARY OF THE INVENTION

It is therefore an object of the invention to provide a power plug of a peripheral device and the corresponding socket thereof capable of preventing the electrical appliance from being damaged and preventing the user from receiving an electric shock when the power plug and the socket are electrically connected.

The invention achieves the above-identified object by providing a power plug of a peripheral device and the corresponding socket thereof. The power plug includes a first plug pin, a second plug pin, a third plug pin and a fourth plug pin respectively protruding a first length, a second length, a third length and a fourth length from a first datum plane of the power plug. The second length is larger than the first length, the third length is substantially the same with the second length, and the fourth length is smaller than the second length. The socket is for electrically connected to the power plug. The socket includes a first socket pin, a second socket pin, a third socket pin and a fourth socket pin respectively protruding a fifth length, a sixth length, a seventh length and an eighth length from a second datum plane of the socket. The sixth length is smaller than the fifth length, the seventh length is substantially the same with sixth length, and the eighth length is larger than the sixth length. While the power plug is electrically connected to the socket, the first plug pin, the second plug pin, the third plug pin and the fourth plug pin respectively contact the first socket pin, the second socket pin, the third socket pin and the fourth socket pin to generate an electrical connection.

The invention achieves the above-identified object by providing another power plug of a peripheral device for electrically connecting a socket. The socket has a first socket pin, a second socket pin, a third socket pin and a fourth socket pin. The power plug includes a first plug pin, a second plug pin, a third plug pin and a fourth plug pin respectively protruding a first length, a second length, a third length and a fourth length from a datum plane of the power plug. The second length is larger than the first length, the third length is substantially the same with the second length, and the fourth length is smaller than the second length. While the power plug is electrically connected to the socket, the second plug pin and the third plug pin respectively contact the second socket pin and the third socket pin first, and then the first plug pin and the fourth plug pin respectively contact the first socket pin and the fourth socket pin to generate an electrical connection.

The invention achieves the above-identified object by providing yet another socket of a peripheral device for being electrically connected a power plug. The power plug has a first plug pin, a second plug pin, a third plug pin and a fourth plug pin. The socket includes a first socket pin, a second socket pin, a third socket pin and a fourth socket pin respectively protruding a first length, a second length, a third length and a fourth length from a datum plane of the socket. The second length is larger than the first length, the third length is substantially the same with the second length, and the fourth length is smaller than the second length. While the power plug is electrically connected to the socket, the second plug pin and the third plug pin respectively contact the second socket pin and the third socket pin first, and then the first plug pin and the fourth plug pin respectively contact the first socket pin and the fourth socket pin to generate an electrical connection.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a three-dimensional diagram of a conventional power plug and a conventional socket;

FIG. 1B (Prior Art) is a cross-sectional view of FIG. 1A;

FIG. 2A (Prior Art) shows a short-circuit when the power plug and the socket in FIG. 1B are electrically connected;

FIG. 2B (Prior Art) shows another short-circuit when the power plug and the socket in FIG. 1 B are electrically connected;

FIG. 3A is a three-dimensional diagram of a power plug of a peripheral device according to a first embodiment of the invention;

FIG. 3B is a cross-sectional view of FIG. 3A;

FIG. 4A is a three-dimensional diagram of a power plug of a peripheral device according to a second embodiment of the invention;

FIG. 4B is a cross-sectional view of FIG. 4A;

FIG. 5A is a three-dimensional diagram of a power plug of a peripheral device and the corresponding socket thereof according to a third embodiment of the invention; and

FIG. 5B is a cross-sectional view of FIG. 5A.

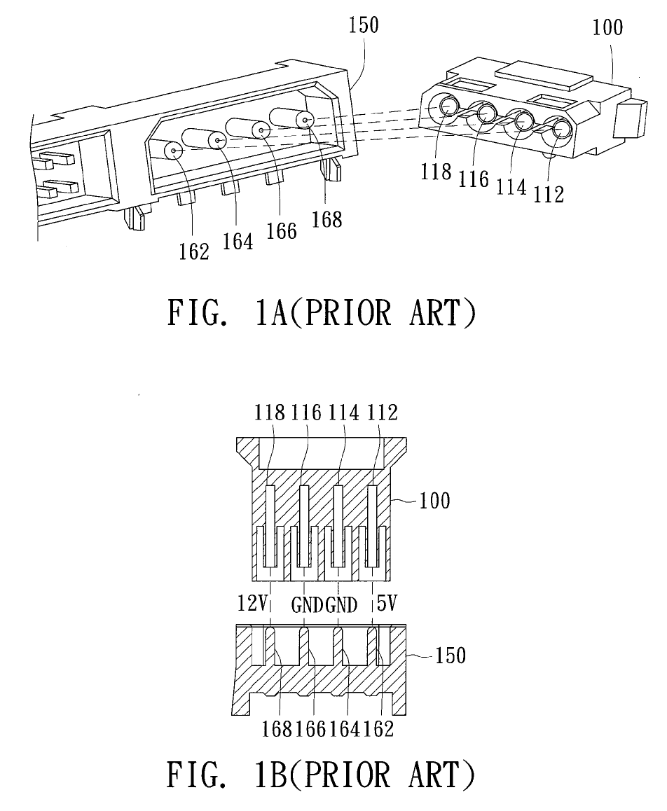

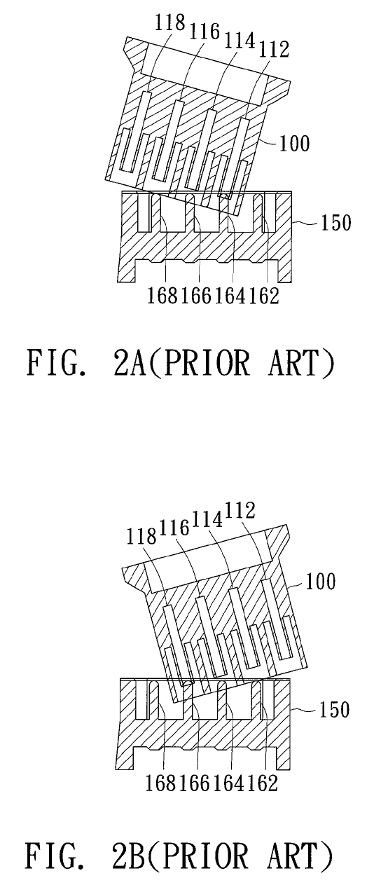

### DETAILED DESCRIPTION OF THE INVENTION

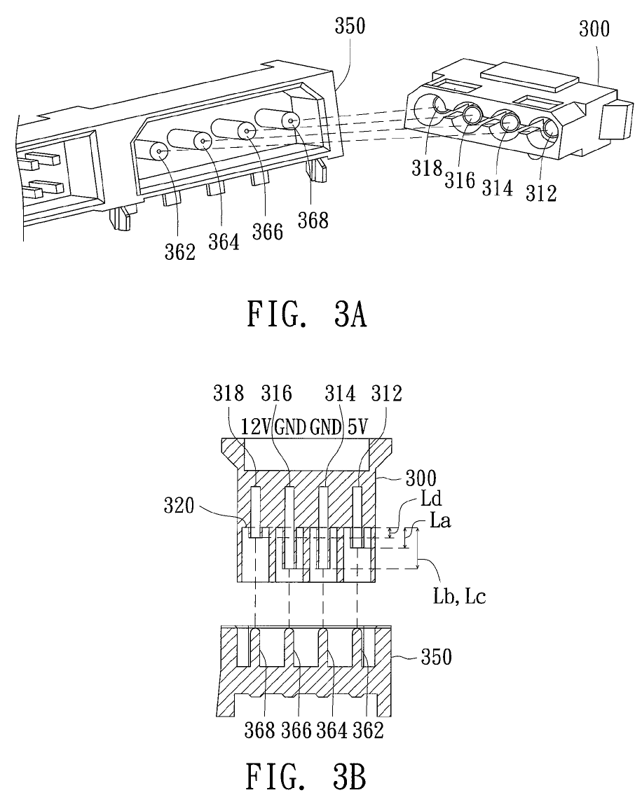

Referring to FIG. 3A and FIG. 3B, a three-dimensional diagram and a cross-sectional view of a power plug of a peripheral device according to a first embodiment of the invention are respectively shown. The power plug 300 is for electrically connecting a socket such as a socket 350 shown in FIG. 3A and FIG. 3B. The power plug 300 can be disposed on a storage device for instance. The storage device receives the necessary power through the socket 350 and a power supplier. The power suppler can be coupled to the power plug 300.

The power plug 300 includes four plug pins 312, 314, 316 and 318, which are respectively coupled to a 5V voltage, a ground end GND, a ground end GND and a 12V voltage provided by a power supplier. The 5V voltage is for providing an ordinary IC with necessary power for instance, and the 12V voltage is for driving a motor for instance. The socket 350 includes four socket pins 362, 364, 366 and 368. When the power plug 300 is connected to the socket 350, the plug pin 312, 314, 316 and 318 respectively contact the socket pins 362, 364, 366 and 368 to generate an electrical connection.

It can be seen from the FIG. 3B that the plug pins 312, 314, 316 and 318 respectively protrude length La, length Lb, length Lc and length Ld from a datum plane 320 of the power plug 300, and the socket pin 362, 364, 366 and 368 are of the same length. The length Lb is larger than the length La and the length Ld, the length Lc is substantially the same with the length Lb, and the length Ld is smaller than the length La as shown in FIG. 3B. Therefore, when the power plug 300 is electrically connected to the socket 350, the plug pin 314 and the plug pin 316 respectively contact the socket pin 364 and the socket pin 366 first, and then the plug pin 312 contacts the socket pin 362, afterwards, the plug pin 318 contacts the socket pin 368 to generate an electrical connection.

That is, when the power plug 300 is electrically connected to the socket 350, the ground end is electrically connected first, the 5V voltage comes next, and the 12V voltage comes last. Not only the object of preventing the storage device from the damage caused by EDS so as to prolong the lifespan of the storage device is achieved, but also the safety of electricity is enhanced.

It is noteworthy that despite the present embodiment is exemplified by letting the length Ld to be smaller than the length La, the length Ld does not necessarily to be smaller than the length La. For example, the length Ld can be substantially the same with the length La. When the power plug 300 is electrically connected to the socket 350, the ground end is electrically connected first, and then the 5V voltage and the 12V voltage are electrically connected next. Through such arrangement, the storage device is also prevented from being damaged by EDS.

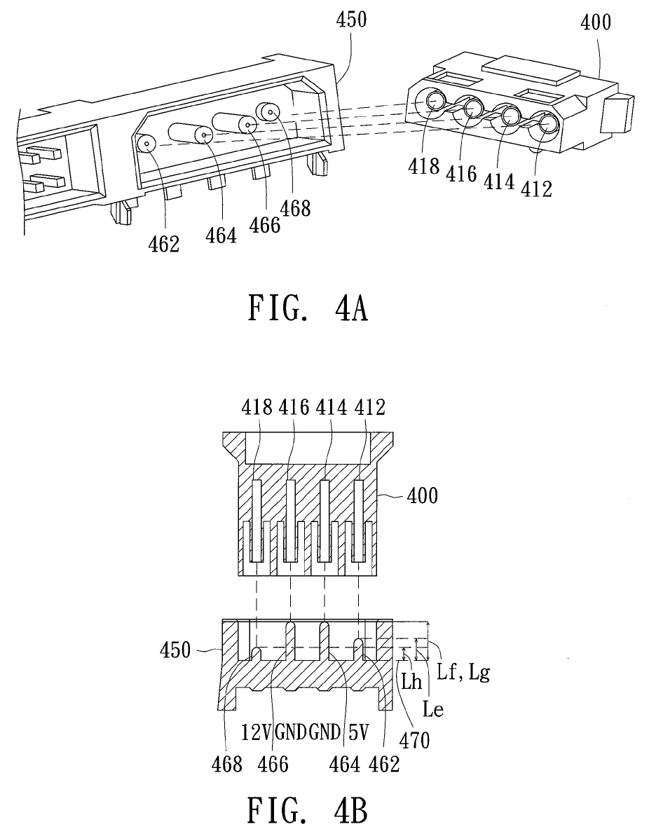

Referring to FIG. 4A and FIG. 4B, a three-dimensional diagram and a cross-sectional view of a power plug of a peripheral device according to a second embodiment of the invention are respectively shown. The socket 450 is for electrically connecting a power plug 400 shown in FIG. 4A and FIG. 4B for instance. The power plug 400 includes four plug pins 412, 414, 416 and 418, and the socket 450 includes four socket pins 462, 464, 466 and 468 respectively coupled to a 5V voltage, a ground end GND, a ground end GND and a 12V voltage provided by a power supplier.

The second embodiment (FIG. 4B) differs with the first embodiment (FIG. 3B) in that plug pins 412, 414, 416 and 418 are of the same length, and socket pins 462, 464, 466 and 468 respectively protrude length Le, length Lf, length Lg and length Lh from a datum plane 470 of the socket 450. The length Lf is larger than the length Le and the length Lh, the length Lg is substantially the same with the length Lf, and the length Lh is smaller than the length Le as shown in FIG. 4B. When the power plug 400 is electrically connected to the socket 450, the plug pin 414 and the plug pin 416 respectively contact the socket pin 464 and the socket pin 466 first, and then the plug pin 412 contacts the socket pin 462, afterwards, the plug pin 418 contacts the socket pin 468 to generate an electrical connection.

That is, when the power plug 400 is electrically connected to the socket 450, the ground end is electrically connected first, the 5V voltage comes next, and the 12V voltage comes last. Not only the object of preventing the storage device from the damage caused by EDS so as to prolong the lifespan of the storage device is achieved, but also the safety of electricity is enhanced.

It is noteworthy that despite the present embodiment is exemplified by letting the length Lh to be smaller than the length Le, the length Lh does not necessarily to be smaller than the length Le. For example, the length Lh can be substantially the same with the length Le. When the power plug 400 is electrically connected to the socket 450, the ground end is electrically connected first, and then the 5V voltage and the 12V voltage are electrically connected next. Through such arrangement, the storage device is also prevented from being damaged by EDS.

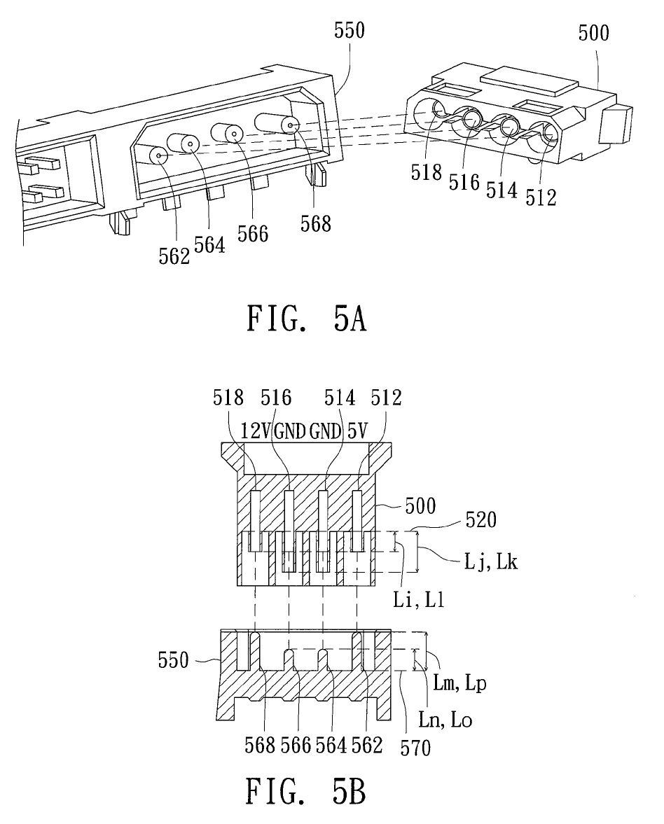

Referring to FIG. 5A and FIG. 5B, a three-dimensional diagram and a cross-sectional view of a power plug of a peripheral device and the corresponding socket thereof according to a third embodiment of the invention are respectively shown. Power plug 500 includes plug pins 512, 514, 516 and 518 respectively coupled to a 5V voltage, a ground end GND, a ground end GND and a 12V voltage provided by a power supplier and arranged according to FIG. 5B. The socket 550 for electrically connecting the power plug 500 includes socket pins 562, 564, 566 and 568.

The plug pins 512, 514, 516 and 518 respectively protrude length Li, length Lj, length Lk and length Ll from a datum plane 520 of the power plug 500. The length Lj is larger than the length Li, the length Lk is substantially the same with the length Lj, and the length Ll is smaller than the length Lj. The socket pins 562, 564, 566 and 568 respectively protrude length Lm, length Ln, length Lo and length Lp from a datum plane 570 of the socket 550. The length Ln is smaller than the length Lm, the length Lo is substantially the same with length Ln, and the length Lp is larger than the length Ln. When the power plug 500 is connected to the socket 550, the plug pins 512, 514, 516 and 518 respectively contact the socket pins 562, 564, 566 and 568 to generate an electrical connection.

For example, the length Ll is let to be substantially the same with length Li, and the length Lp is let to be substantially the same with length Lm as shown in FIG. 5B. Under normal circumstances, the plug pins 512, 514, 516 and 518 can respectively contact the socket pins 562, 564, 566 and 568 to generate an electrical connection. When the power plug 500 is connected to but not aligned with the socket 550, since both the length of the plug pins 512 and 518 and the length of the socket pins 564 and 566 are all short, the unexpected short-circuit is thus avoided. The power plug of a peripheral device and the corresponding socket thereof according to the third embodiment would not cause the computer to break down, the driver to be burnt down, or the user to be exposed to an electric shock due to the misalignment between the power plug and the socket.

Despite the above embodiment is exemplified by letting the length Ll and the length Lp to be equal to the length Li and the length Lm respectively, the length Li does not necessarily to be equal to the length Li, and the length Lp does not necessarily to be equal to the length Lm either. As long as the restriction that the length Li and the length Ll being smaller than the length Lj is satisfied, the relationship between the length Li and the length Ll can be designed according to actual needs. Likewise, as long as the restriction that the length Lm and the length Lp being larger than the length Ln is satisfied, the relationship between the length Lm and the length Lp can be designed according to actual needs. For example, when the plug pins 512, 514, 516 and 518 are arranged according to FIG. 5B, the lengths Li, Lj, Lk, Li, Lm, Ln, Lo and Lp are let to be equal to 6 cm, 8 cm, 8 cm, 3 cm, 5 cm, 4 cm, 4 cm and 7 cm respectively. Thus, the unexpected short-circuit occurring when the power plug and the socket are misaligned can be avoided.

Besides, the sum of the length Lj and the length Ln as well as the sum of the length Lk and the length Lo are larger than the sum of the length Li and the length Lm, and the sum of the length Li and the length Lm is larger than the sum of the length Li and the length Lp. That is, (Lj+Ln)=(Lk+Lo)>(Li+Lm)>(Ll+Lp). Therefore, while the power plug is electrically connected to the socket, the ground end is electrically connected first, then the 5V voltage comes next, and the 12V voltage comes last. Such design provides the power plug of a peripheral device and the corresponding socket thereof according to the third embodiment with enhanced features of preventing EDS and improving the safety of electricity.

The power plug of a peripheral device and the corresponding socket thereof disclosed in above embodiments of the invention prevents the electrical appliance from being damaged and protects the user from electric shock when the power plug is electrically connected to the socket.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power plug of a peripheral device and a corresponding socket of the power plug, wherein
the power plug is coupled to a power supplier, comprising a plurality of plug pins respectively protruding corresponding lengths from a first datum plane of the power plug, at least one of the corresponding lengths being shorter than others of the corresponding lengths; and
the socket electrically is connected to the power plug, comprising a plurality of socket pins respectively protruding corresponding lengths from a second datum plane of the socket, at least one of the corresponding lengths being longer than others of the corresponding lengths, the plug pin with the shorter corresponding length and the socket pin with the longer corresponding length being disposed correspondingly;
wherein when the power plug is electrically connected to the socket, the plug pins respectively contact the corresponding socket pins to generate an electrical connection.

2. The power plug of a peripheral device and the corresponding socket thereof according to claim 1, the plug pins comprising:
a first plug pin protruding a first length from the first datum plane;
a second plug pin protruding a second length from the first datum plane, wherein the second length is larger than the first length;
a third plug pin protruding a third length from the first datum plane, wherein the third length is substantially the same with the second length; and
a fourth plug pin protruding a fourth length from the first datum plane, wherein the fourth length is smaller than the second length; and
the socket pins comprising:
a first socket pin protruding a fifth length from the second datum plane;
a second socket pin protruding a sixth length from the second datum plane, wherein the sixth length is smaller than the fifth length;
a third socket pin protruding a seventh length from the second datum plane, wherein the seventh length is substantially the same with the sixth length; and
a fourth socket pin protruding an eighth length from the second datum plane, wherein the eighth length is larger than the sixth length;
wherein when the power plug is electrically connected to the socket, the first plug pin, the second plug pin, the third plug pin and the fourth plug pin respectively contact the first socket pin, the second socket pin, the third socket pin and the fourth socket pin to generate an electrical connection.

3. The power plug of a peripheral device and the corresponding socket thereof according to claim 2, wherein the first plug pin is electrically connected to a first voltage of the power supplier, the second plug pin and the third plug pin are electrically connected to a ground end of the power supplier, the fourth plug pin is electrically connected to a second voltage of the power supplier, and the second voltage is larger than the first voltage.

4. The power plug of a peripheral device and the corresponding socket thereof according to claim 2, wherein the first length is substantially the same with the fourth length, and the fifth length is substantially the same with the eighth length.

5. The power plug of a peripheral device and the corresponding socket thereof according to claim 2, wherein a sum of the second length and the sixth length as well as a sum of the third length and the seventh length are substantially larger than a sum of the first length and the fifth length, the sum of the first length and the fifth length is substantially larger than a sum of the fourth length and the eighth length, while the power plug is electrically connected to the socket, the second plug pin and the third plug pin respectively contact the second socket pin and the third socket pin first, then the first plug pin contacts the first socket pin, afterwards, the fourth plug pin contacts contact the fourth socket pin to generate an electrical connection.

6. A power plug of a peripheral device for being electrically connected to a socket, wherein the socket has a plurality of socket pins, the power plug is coupled to a power supplier, and the power plug comprises:
a plurality of plug pins respectively protruding corresponding lengths from a datum plane of the power plug, wherein at least one of the corresponding lengths is shorter than others of the corresponding lengths, when the power plug is electrically connected to the socket, the plug pins respectively contact the corresponding socket pins to generate an electrical connection.

7. The power plug according to claim 6, wherein the plug pins comprises:
a first plug pin protruding a first length from the datum plane;
a second plug pin protruding a second length from the datum plane, wherein the second length is larger than the first length;
a third plug pin protruding a third length from the datum plane, wherein the third length is substantially the same with the second length; and
a fourth plug pin protruding a fourth length from the datum plane, wherein the fourth length is smaller than the second length;
wherein the socket has a first socket pin, a second socket pin, a third socket pin and a fourth socket pin, when the power plug is electrically connected to the socket, the second plug pin and the third plug pin respectively contact the second socket pin and the third socket pin first, and then the first plug pin and the fourth plug pin respectively contact the first socket pin and the fourth socket pin to generate an electrical connection.

8. The power plug according to claim 6, wherein the second plug pin and the third plug pin are electrically connected to a ground end of the power supplier.

9. The power plug according to claim 7, wherein the fourth length is smaller than the first length, when the power plug is electrically connected to the socket, the fourth plug pin contact the fourth socket pin to generate an electrical connection after the first plug pin contacts the first socket pin.

10. The power plug according to claim 9, wherein the first plug pin is electrically connected to a first voltage of the power supplier, the fourth plug pin is electrically connected to a second voltage of the power supplier, and the second voltage is larger than the first voltage.

11. The power plug according to claim 7, wherein the fourth length is substantially the same with the first length.

12. A socket of a peripheral device for being electrically connected to a power plug, wherein the power plug has a plurality of plug pins, the socket is coupled to a power supplier, and the socket comprises:
a plurality of socket pins respectively protrude corresponding lengths from a datum plane of the socket, wherein at least one of the corresponding lengths is shorter than others of the corresponding lengths, when the power plug is electrically connected to the socket, the plug pins respectively contact the corresponding socket pins to generate an electrical connection.

13. The socket according to claim 12, wherein the socket pins comprises:
a first socket pin protruding a first length from the datum plane;
a second socket pin protruding a second length from the datum plane, wherein the second length is larger than the first length;
a third socket pin protruding a third length from the datum plane, wherein the third length is substantially the same with the second length; and
a fourth socket pin protruding a fourth length from the datum plane, wherein the fourth length is smaller than the second length;
wherein the power plug has a first plug pin, a second plug pin, a third plug pin and a fourth plug pin, when the power plug is electrically connected to the socket, the second plug pin and the third plug pin respectively contact the second socket pin and the third socket pin first, and then the first plug pin and the fourth plug pin respectively contact the first socket pin and the fourth socket pin to generate an electrical connection.

14. The socket according to claim 13, wherein the second socket pin and the third socket pin are electrically connected to a ground end of the power supplier.

15. The socket according to claim 13, wherein the fourth length is smaller than the first length, when the power plug is electrically connected to the socket, the fourth plug pin contacts the fourth socket pin to generate an electrical connection after the first plug pin contacts the first socket pin.

16. The socket according to claim 15, wherein the first socket pin is electrically connected to a first voltage of the power supplier, the fourth socket pin is electrically connected to a second voltage of the power supplier, and the second voltage is larger than the first voltage.

17. The socket according to claim 13, wherein the fourth length is substantially the same with the first length.
